(19) United States
(12) Patent Application Publication
(10) Pub. No.: US 2019/0205804 A1
(43) Pub. Date: Jul. 4, 2019

(54) INFORMATION PROCESSING DEVICE, INFORMATION PROCESSING METHOD AND COMPUTER READABLE MEDIUM

(71) Applicant: MITSUBISHI ELECTRIC CORPORATION, Tokyo (JP)

(72) Inventors: Kengo SHIRAKI, Tokyo (JP); Haruyuki OTANI, Tokyo (JP)

(73) Assignee: MITSUBISHI ELECTRIC CORPORATION, Tokyo (JP)

(21) Appl. No.: 16/325,353

(22) PCT Filed: Sep. 7, 2016
(86) PCT No.: PCT/JP2016/076318

§ 371 Date: Feb. 13, 2019

(51) Int. Cl. G06Q 10/06

(52) U.S. Cl. CPC G06Q 10/06313; G06Q 10/06316

(57) ABSTRACT

A process division unit selects a worker that matches a selection condition from a plurality of workers. Further, the process division unit analyzes, with respect to a selected worker being the worker selected, a decreasing state of a working hour due to increase in the number of times of carrying out a working process, and determines whether to divide the working process or not.

### TECHNICAL FIELD

The present invention relates to an information processing device, an information processing method and an information processing program.

### BACKGROUND ART

In factories, one product is produced through a plurality of working processes. One worker is hardly in charge of all of a plurality of working processes, and a plurality of workers often share a plurality of working processes. At this time, two or more workers may carry out the same working process in parallel.

Further, two or more workers may often share one working process on different working days.

Generally, a working procedure is specified for each working process and a standard time is set, the standard time being required for completion of work if the work is carried out in accordance with the working procedure. However, performance at a time of carrying out a work differs between respective workers. Further, the time taken for the work differs between an occasion in which a worker carries out the work for the first time, and an occasion in which the same worker has gotten used to the work through repeating the work.

Therefore, actual working hours actually taken for the work may largely differ from the standard time.

Patent Literature 1 discloses a system to calculate an estimated working hour in accordance with a cumulative number of times of carrying out a same working process, by using result data of working hours of workers. In the system of Patent Literature 1, by using the result data of working hours for an arbitrary working process, a learning curve representing a proficiency level of workers with respect to the working process is generated, and working hours after repeating the work is estimated by using the learning curve generated.

### CITATION LIST

### Patent Literature

Patent Literature 1: JP 2005-284415 A

### SUMMARY OF INVENTION

### Technical Problem

Among a plurality of working processes included in a production line in a factory, there are working processes which are difficult to learn and less prone to reduce the working hours even after repeating the work, and working processes which are easy to learn and prone to reduce the working hours. In terms of optimization of a work plan, it is desirable to develop a work plan after distinguishing the working processes which are difficult to learn from the working processes which are easy to learn.

That is, when working processes which are difficult to learn, and which are difficult to reduce the working hours are included in a production line in a factory, it is desirable to divide the working processes which are difficult to reduce the working hours to decrease the working hours.

The technique of Patent Literature 1 calculates estimated working hours for respective working processes; however, the technique of Patent Literature 1 does not determine whether to divide the working processes or not. Therefore, there is a problem that a work manager who manages working processes cannot develop an optimum work plan including division of the working processes.

The present invention is mainly aimed at resolving such a problem. That is, the present invention is mainly aimed at obtaining a configuration to determine whether to divide a working process or not.

### Solution to Problem

An information processing device according to the present invention, includes:

a worker selection unit to select a worker that matches a selection condition from a plurality of workers, and

a division determination unit to analyze, with respect to a selected worker being the worker selected by the worker selection unit, a decreasing state of a working hour due to increase in the number of times of carrying out a working process, and determine whether to divide the working process or not.

### Advantageous Effects of Invention

According to a present invention, it is possible to determine whether to divide a working process.

### BRIEF DESCRIPTION OF DRAWINGS

FIG. 1 is a diagram illustrating an example of a system configuration according to a first embodiment;

FIG. 2 is a diagram illustrating an example of a hardware configuration of an information processing device according to the first embodiment;

FIG. 3 is a diagram illustrating an example of a functional configuration of the information processing device according to the first embodiment;

FIG. 4 is a flowchart illustrating an operation example of the information processing device according to the first embodiment;

FIG. 5 is a flowchart illustrating an operation example of the information processing device according to the first embodiment;

FIG. 6 is a diagram illustrating an example of a functional configuration of an information processing device according to a second embodiment;

FIG. 7 is a diagram illustrating an example of a learning curve according to the second embodiment;

FIG. 8 is a flowchart illustrating an operation example of the information processing device according to the second embodiment;

FIG. 9 is a flowchart illustrating an operation example of the information processing device according to the second embodiment; and

FIG. 10 is flowchart illustrating an operation example of the information processing device according to the second embodiment.

### DESCRIPTION OF EMBODIMENTS

Hereinbelow, embodiments of the present invention will be described with use of the drawings. In following description and the drawings on the embodiments, elements provided with identical reference characters represent identical elements or corresponding elements.

### First Embodiment

***Explanation of Configuration***

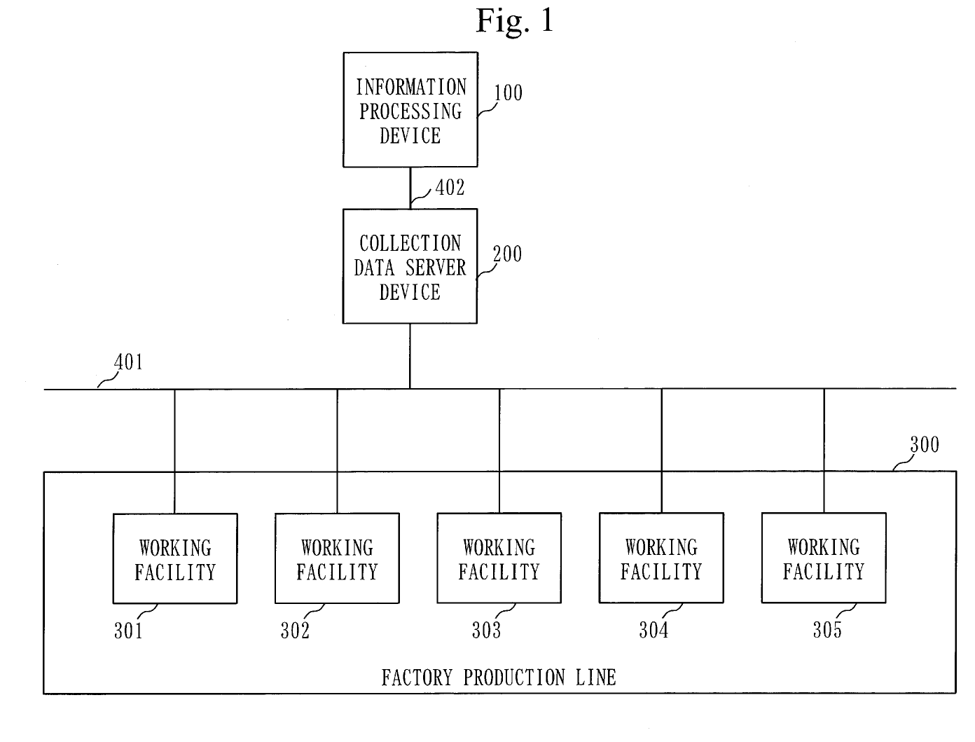

FIG. 1 illustrates an example of a system configuration according to the present embodiment.

The system according to the present embodiment is configured by an information processing device 100, a collection data server device 200 and a factory production line 300. In the factory production line 300, working facilities 301 through 305 exist.

In the present embodiment, working processes correspond to the working facilities 301 through 305.

That is, in the present embodiment, there are five working processes of a working process using the working facility 301, a working process using the working facility 302, a working process using the working facility 303, a working process using the working facility 304 and a working process using the working facility 305, in the factory production line 300.

Hereinafter, the working process using the working facility 301 is called a working process 1. Further, the working process using the working facility 302 is called a working process 2. Furthermore, the working process using the working facility 303 is called a working process 3. The working process using the working facility 304 is called a working process 4. The working process using the working facility 305 is called a working process 5.

Further, in the present embodiment, the respective working processes are carried out by a plurality of workers. However, combination of workers and the number of workers in the respective working processes may differ.

Furthermore, in the present embodiment, respective workers are in charge of one or more working processes. A worker who is in charge of only one working process may exist; however, workers of at least a half of the number of all the workers are in charge of two or more working processes.

The information processing device 100 determines whether to divide working processes or not by using working-hour data collected by the collection data server device 200. Further, the information processing device 100 optimizes a work plan.

The working-hour data is data indicating a history of working hours on a worker-by-worker basis for respective working processes.

The information processing device 100 is connected to the collection data server device 200 via a network 402.

The operations performed by the information processing device 100 correspond to an information processing method and an information processing program.

The collection data server device 200 collects working-hour data from the factory production line 300. There may be any methods to collect the working-hour data by the collection data server device 200.

The collection data server device 200 is connected to the working facilities 301 through 305 via a network 401.

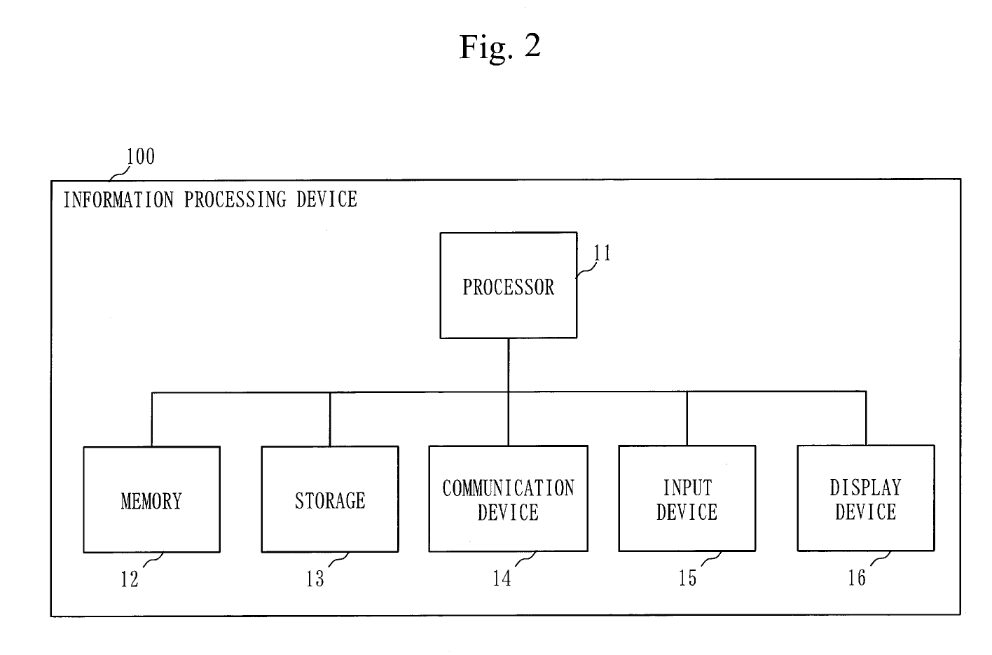

FIG. 2 illustrates an example of a hardware configuration of the information processing device 100.

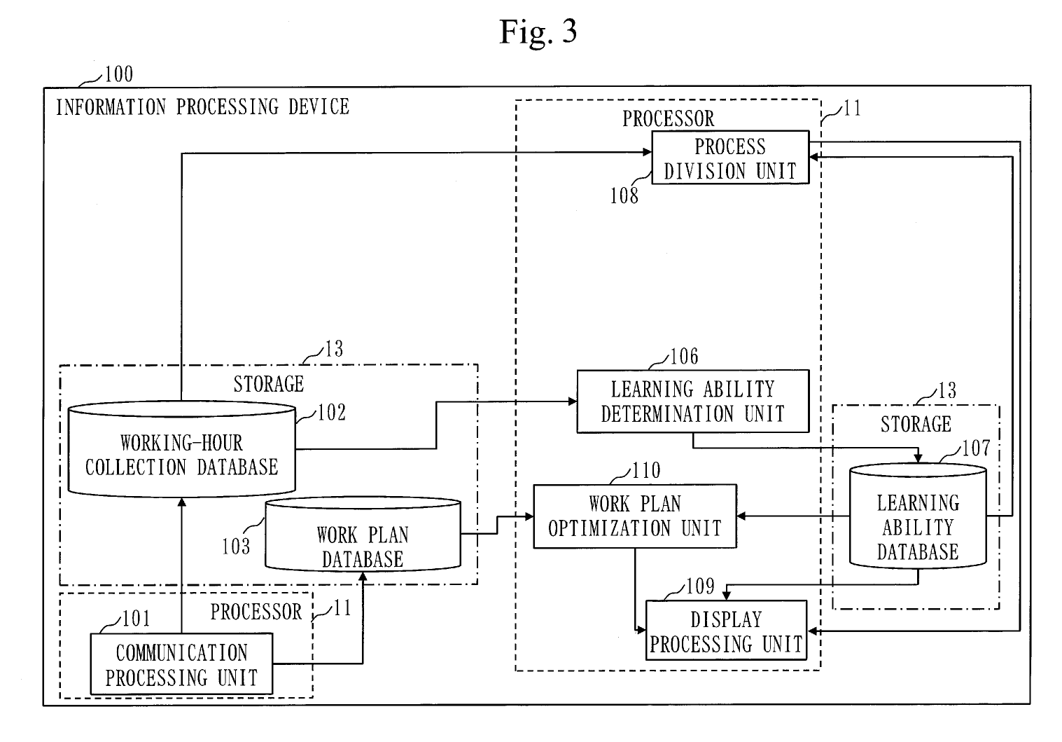

FIG. 3 illustrates an example of a functional configuration of the information processing device 100.

First, with reference to FIG. 2, the example of the hardware configuration of the information processing device 100 is described.

The information processing device 100 is a computer.

The information processing device 100 is equipped with a processor 11, a memory 12, a storage 13, a communication device 14, an input device 15 and a display device 16, as hardware.

The storage 13 stores programs to realize functions of a communication processing unit 101, a learning ability determination unit 106, a process division unit 108, a display processing unit 109 and a work plan optimization unit 110 illustrated in FIG. 3.

Then, these programs are loaded into the memory 12, and the processor 11 executes these programs.

Further, the storage 13 realizes a working-hour collection database 102, a work plan database 103 and a learning ability database 107 illustrated in FIG. 3. FIG. 3 schematically denotes a state wherein the processor 11 executes the programs to realize the functions of the communication processing unit 101, the learning ability determination unit 106, the process division unit 108, the display processing unit 109 and the work plan optimization unit 110. Further, FIG. 3 schematically denotes a state wherein the storage 13 is used as the working-hour collection database 102, the work plan database 103 and the learning ability database 107. Note that at least a part of the working-hour collection database 102, the work plan database 103 and the learning ability database 107 may be realized by the memory 12.

Next, with reference to FIG. 3, an example of the functional configuration of the information processing device 100 is described.

The communication processing unit 101 receives working-hour data from the collection data server device 200, by using the communication device 14. Then, the communication processing unit 101 stores the working-hour data received in the working-hour collection database 102.

Further, the communication processing unit 101 receives work plan data from the collection data server device 200. Then, the communication processing unit 101 stores the work plan data received in the work plan database 103.

The learning ability determination unit 106 determines learning ability of each of a plurality of workers by using the working-hour data.

Further, the learning ability determination unit 106 stores worker learning-ability data which denotes determination results for respective workers in the learning ability database 107.

The process division unit 108 selects a worker that matches a selection condition from the plurality of workers. More specifically, the process division unit 108 selects a worker whose learning ability determined by the learning ability determination unit 106 matches the selection condition.

Then, the process division unit 108 analyzes a decreasing state of working hours associated with increase in the number of times of carrying out a working process for a selected worker being the worker selected, and determines whether to divide the working process or not. More specifically, when the working hours do not decrease even when the number of times of carrying out increases in a working process, the process division unit 108 determines that the working process should be divided.

The process division unit 108 corresponds to a worker selection unit and a division determination unit. Further, the operation of the process division unit 108 corresponds to a worker selection process and a division determination process.

The work plan optimization unit 110 optimizes the work plan by using the work plan data stored in the work plan database 103 and the learning ability data stored in the worker learning ability database 107.

The display processing unit 109 displays the determination results of the learning ability determination unit 106, the determination results of the process division unit 108, and the work plan optimized by the work plan optimization unit 110 on the display device 16.

***Explanation of Operation***

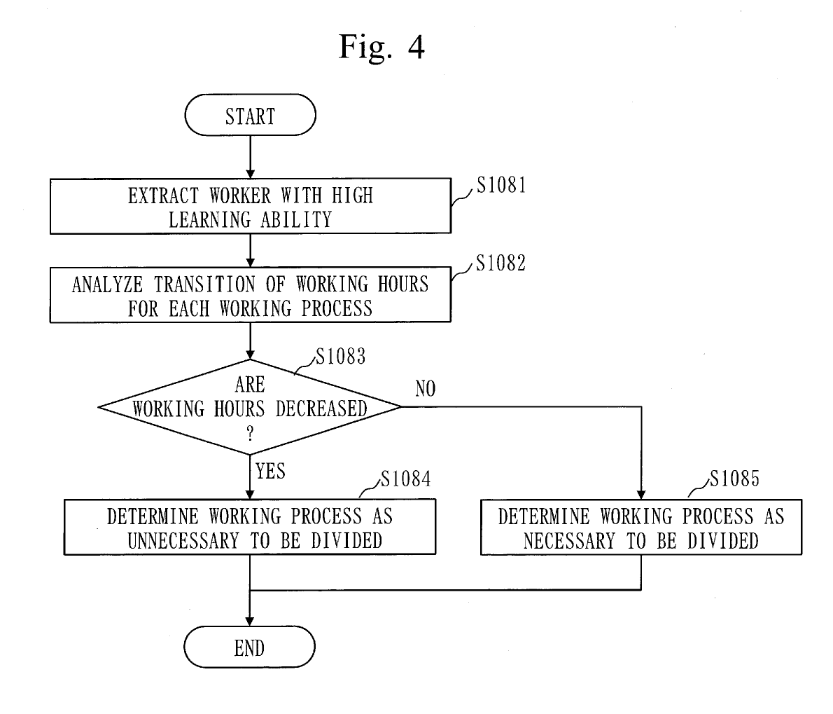

Next, with reference to a flowchart in FIG. 4, explanation is provided of an operation to determine division of a working process.

In a step S1081, the process division unit 108 extracts workers having high learning ability through all the working processes. That is, the process division unit 108 selects workers that match a selection condition that learning ability should be more than a predetermined level. Note that the workers extracted by the process division unit 108 correspond to selected workers.

It is assumed that the learning ability of each worker for each working process is determined by the learning ability determination unit 106. The learning ability determination unit 106 can determine the learning ability of each worker in an arbitrary method.

Next, in a step S1082, the process division unit 108 analyzes transition of working hours for each working process.

More specifically, the process division unit 108 acquires working-hour data of the workers extracted (selected workers) in the step S1081 from the working-hour collection database 102. Then, the process division unit 108 analyzes transition of the working hours of the workers extracted in the step S1081 for each working process.

For example, it is assumed a case wherein a worker A and a worker B are extracted in the step S1081, wherein the worker A is in charge of a working process 1 and a working process 2, and the worker B is in charge of the working process 2 and a working process 3. The process division unit 108 analyzes a decreasing state of the working hours of the worker A due to increase in the number of times of carrying out the working process 1, and analyzes a decreasing state of the working hours of the worker A due to increase in the number of times of carrying out the working process 2. Similarly, the process division unit 108 analyzes a decreasing state of the working hours of the worker B due to increase in the number of times of carrying out the working process 2, and analyzes a decreasing state of the working hours of the worker B due to increase in the number of times of carrying out the working process 3.

In this manner, the process division unit 108 analyzes the decreasing states of working hours of the workers extracted in the step S1081 for each working process.

Next, in a step S1083, the process division unit 108 determines whether working hours decrease or not for each working process.

In particular, for a same working process, the process division unit 108 compares a mean value of working hours of each worker at the time when a working process is carried out for the first time, and a mean value of working hours of each worker at the time when the working process is carried out for the 20th time. When the mean value of the working hours at the 20th time is equal to or less than 80% of the mean value of the working hours at the first time of carrying out, or is less than a standard number of hours, the process division unit 108 determines that the working hours of the target process are decreased, and in the other cases, determines that the working hours are not decreased.

When the working hours are decreased (YES in the step S1083), the process division unit 108 determines the working process as a working process unnecessary to be divided (step S1084).

Meanwhile, when the working hours are not decreased (NO in the step S1083), the process division unit 108 determines the working process as a working process necessary to be divided (step S1085).

For example, when the working hours in the working process 1 are not decreased, the process division unit 108 determines that the working process 1 should be divided.

When it is determined by the process division unit 108 that a working process should be divided, it may be applicable to have the display processing unit 109 display the target working process on the display device 16 to inquire of a work manager for whether or not to divide the working process.

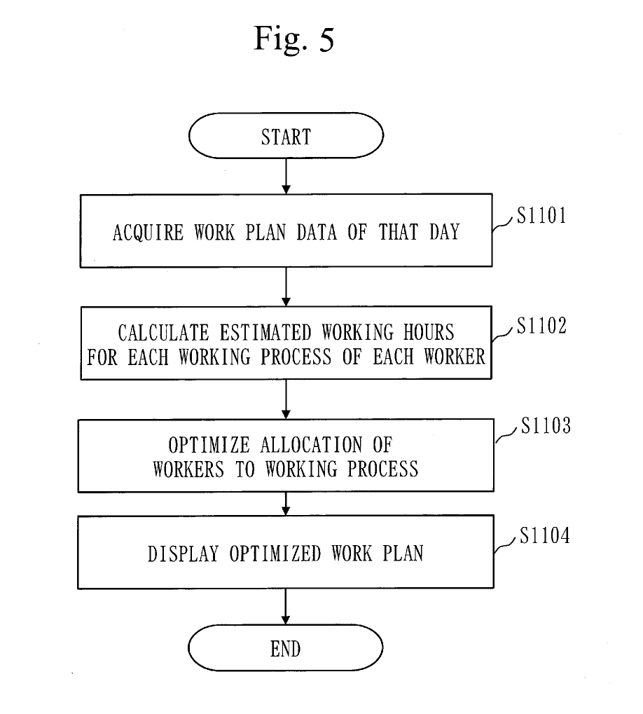

Next, explanation is provided of an operation to optimize a work plan with reference to a flowchart of FIG. 5.

First, in a step S1101, the work plan optimization unit 110 acquires work plan data of that day from the work plan database 103. In the work plan data, type and quantity of a product to be manufactured on that day, and on-duty hours of workers who work on that day are described.

Next, in a step S1102, the work plan optimization unit 110 calculates estimated working hours for each working process of each worker from the working process and the learning ability of the workers.

The work plan optimization unit 110 calculates estimated working hours for each working process of each worker by using, for example, the total sum average C of decrease rate A for each worker and decrease rate B for each working process. The decrease rate A for each worker is a mean value of ratios between working hours at each number of times of carrying out and the working hours at the first time with respect to all the working processes that target workers have carried out. That is, the decrease rate A for each worker denotes a degree of decrease of working hours of the target workers for all the working processes. The decrease rate B for each working process is a mean value of ratios between working hours at each number of times of carrying out and the working hours at the first time with respect to all the workers who have carried out the target working process. That is, the decrease rate B for each working process denotes a degree of decrease of working hours of the target working process for all the workers. The work plan optimization unit 110 calculates decrease rate D between working hours at the first time of carrying out and working hours at each number of times, by using the total sum average C of the decrease rate A for each worker and the decrease rate B for each working process, when each worker performs each working process. Then, the work plan optimization unit 110 calculates estimated working hours on a worker-by-worker basis for each working process for each number of times of carrying out, by multiplying working hours at the first time of carrying out a target working process and the decrease rate D.

Next, in a step S1103, the work plan optimization unit 110 optimizes allocation of workers to each working process. Specifically, the work plan optimization unit 110 optimizes allocation of workers so as to minimize the total estimated working hours of all the working processes.

The work plan optimization unit 110 uses, as an optimization method of allocation of workers, linear programming, for example. That is, the work plan optimization unit 110 sets type and quantity of working processes to be processed on that day, on-duty hours of each worker who work on that day, and estimated working hours of each working process as a constraint condition, and determines workers of each working process so as to minimize the sum of the estimated working hours of all the working processes. By the linear programming, allocation of workers of each working process on that day is optimized.

Lastly, in a step S1104, the display processing unit 109 displays allocation of workers optimized which is obtained in the step S1103 on the display device 16 as an optimized work plan.

***Explanation of Effect of Embodiment***

According to the present embodiment, a decrease state of working hours is analyzed, and whether to divide working processes is determined. Therefore, according to the present embodiment, a work manager can make an optimal work plan including division of working processes.

### Second Embodiment

In a present embodiment, explanation is provided of an example wherein, by using a learning curve and determination coefficients of each worker for each working process, learning ability of each worker is determined with more precision, and further, by using the determination coefficients, whether to divide working processes is determined with more precision.

***Explanation of Configuration***

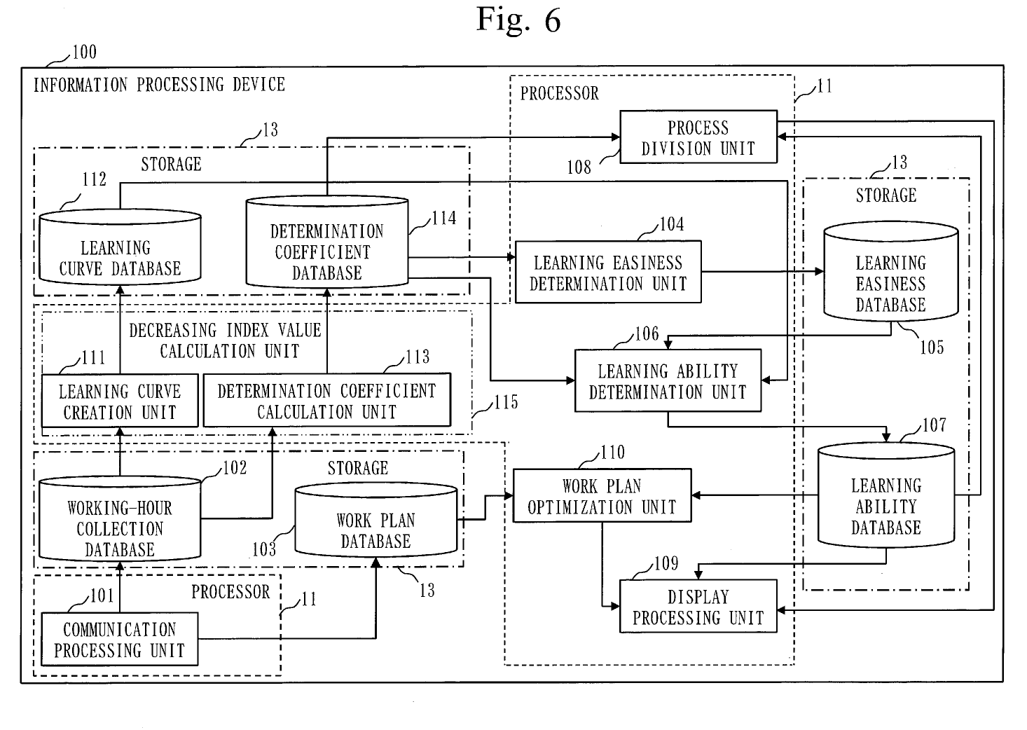

FIG. 6 illustrates an example of a functional configuration of the information processing device 100 according to the present embodiment.

Compared to FIG. 3, in FIG. 6, a learning easiness determination unit 104, a learning easiness database 105, a learning curve creation unit 111, a learning curve database 112, a determination coefficient calculation unit 113 and a determination coefficient database 114 are added.

The other elements are the same as those illustrated in FIG. 3.

Note that in the present embodiment as well, the functions of the communication processing unit 101, the learning easiness determination unit 104, the learning ability determination unit 106, the process division unit 108, the display processing unit 109, the work plan optimization unit 110, the learning curve creation unit 111 and the determination coefficient calculation unit 113 are realized through execution of programs by the processor 11. FIG. 6 schematically illustrates a state wherein the programs to realize the functions of the communication processing unit 101, the learning easiness determination unit 104, the learning ability determination unit 106, the process division unit 108, the display processing unit 109, the work plan optimization unit 110, the learning curve creation unit 111 and the determination coefficient calculation unit 113 are executed by the processor 11.

Further, the working-hour collection database 102, the work plan database 103, the learning easiness database 105, the learning ability database 107, the learning curve database 112 and the determination coefficient database 114 are realized by the storage 13. FIG. 6 schematically illustrates that the working-hour collection database 102, the work plan database 103, the learning easiness database 105, the learning ability database 107, the learning curve database 112 and the determination coefficient database 114 are realized by the storage 13. Note that at least a part of the working-hour collection database 102, the work plan database 103, the learning easiness database 105, the learning ability database 107, the learning curve database 112 and the determination coefficient database 114 may be realized by the memory 12.

The learning curve creation unit 111 creates a learning curve on a worker-by-worker basis for respective working processes using the working-hour data stored in the working-hour collection database 102. The learning curve is a curve indicating relation between the number of times of carrying out a working process and working hours in the working process. Then, the learning curve creation unit 111 stores learning curve data wherein learning curves created are described in the learning curve database 112.

The determination coefficient calculation unit 113 calculates determination coefficients between the learning curves created by the learning curve creation unit 111 and the histories of working hours indicated in the working-hour data. Further, the determination coefficient calculation unit 113 stores determination coefficient data describing the determination coefficients calculated in the determination coefficient database 114. The determination coefficient is an index value to represent a decreasing state in working hours due to increase in the number of times of carrying out, and corresponds to a decreasing index value.

Note that the learning curve creation unit 111 and the determination coefficient calculation unit 113 may be also called a decreasing index value calculation unit 115.

The learning easiness determination unit 104 determines whether each working process is a working process easy to learn based on determination coefficients (decreasing index values) of a plurality of workers.

Further, the learning easiness determination unit 104 stores learning easiness data describing determination results regarding each working process in the learning easiness database 105.

In the present embodiment, the learning ability determination unit 106 determines a learning ability of each worker using the determination coefficient of the working processes that are determined as working processes easy to learn by the learning easiness determination unit 104.

Further, in the present embodiment, the process division unit 108 analyzes determination coefficients (decreasing index values) of selected workers and determines whether to divide the working process. More specifically, the process division unit 108 calculates a mean value of the determination coefficients of the selected workers, and when the mean value calculated is less than a threshold value, determines that the working process should be divided.

The example of the hardware configuration of the information processing device 100 according to the present embodiment is the same as that illustrated in FIG. 2.

Hereinafter, difference from the first embodiment will be mainly described. The items not explained below are the same as those in the first embodiment.

***Explanation of Operation***

First, explanation is provided of a creation procedure of a learning curve by the learning curve creation unit 111.

The learning curve creation unit 111 creates a learning curve on a worker-by-worker basis for respective working processes using the working-hour data stored in the working-hour collection database 102. For example, when a worker A is in charge of a working process 1 and a working process 2, the learning curve creation unit 111 creates a learning curve of the worker A with respect to the working process 1, and a learning curve of the worker A with respect to the working process 2. The learning curve creation unit 111 stores the learning curve data describing the learning curve created in the learning curve database 112.

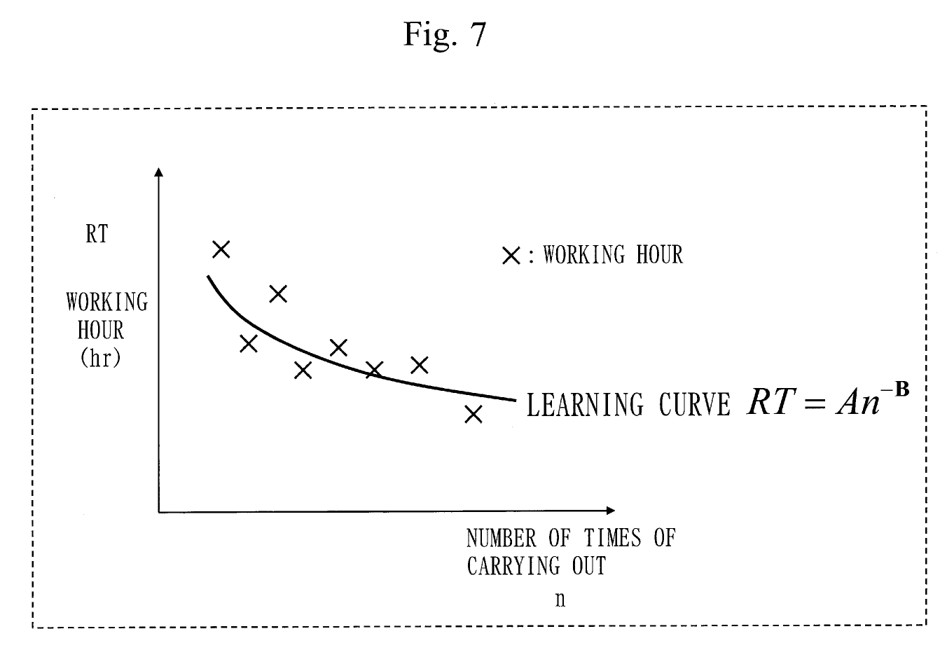

FIG. 7 illustrates an example of the learning curve. Since workers generally get used to a work by repeating a same working process, working hours tend to decrease as the number of times of carrying out increases. Also in the example of FIG. 7, working hours RT decrease as the number of times of carrying out n increases.

The decreasing tendency of working hours is approximated by an expression (1). In the expression (1), RT is working hours required until work completion, and n is the number of times of carrying out a working process.

[Formula 1]

RT=An^{-B} Expression (1)

Further, A and B in the expression (1) are variables obtained by following expressions (2) and (3).

In the following, n denotes the number of times of carrying out, N denotes a cumulative number of carrying out, n- (n with - above) denotes a mean value of cumulative numbers of works, RTₙ denotes working hours at the time when the work is carried out for the n-th times, and RT- (RT with - above) denotes a mean value of working hours of all number of times of carrying out.

$$\begin{matrix}[ Formula 2 ] & \\ A = \frac{{\sum }_{n = 1}^{N} ( n - \overline{n} ) ( {RT}_{n} - \overline{RT} )}{{\sum }_{n = 1}^{N} {( n - \overline{n} )}^{2}} & Expression ( 2 ) \\ B = {exp ( \overline{RT} - A \overline{n} )}^{2} & Expression ( 3 )\end{matrix}$$

Next, explanation is provided of a calculation procedure of a determination coefficient by the determination coefficient calculation unit 113.

The determination coefficient calculation unit 113 collates a learning curve created by the learning curve creation unit 111 with the history of working hours indicated in working-hour data of the corresponding working process and the corresponding worker, and calculates a determination coefficient R². Further, the determination coefficient calculation unit 113 stores determination coefficient data describing the determination coefficient R² calculated in the determination coefficient database 114.

For example, the determination coefficient calculation unit 113 collates a learning curve of the worker A with respect to the working process 1 with a history of working hours indicated in working-hour data of the worker A with respect to the working process 1, and calculates the determination coefficient R².

The determination coefficient R² is an index indicating a degree of relevance between a learning curve and an actual working hour, taking a value of [0, 1]. The degree of relevance of the learning curve to the actual working hour becomes larger as the determination coefficient becomes closer to 1, and becomes smaller as the determination coefficient becomes closer to 0. The determination coefficient R² is obtained by an expression (4).

$$\begin{matrix}[ Formula 3 ] & \\ {R}^{2} = \frac{{( {\sum }_{n = 1}^{N} ( n - \overline{n} ) ( {RT}_{n} - \overline{RT} ) )}^{2}}{{\sum }_{n = 1}^{N} {( n - \overline{n} )}^{2} {\sum }_{n = 1}^{N} {( {RT}_{n} - \overline{RT} )}^{2}} & Expression ( 4 )\end{matrix}$$

Next, explanation is provided of a determination procedure of easiness to learn (learning easiness) for each working process by the learning easiness determination unit 104.

The learning easiness determination unit 104 determines easiness to learn for each working process, by using the determination coefficient R².

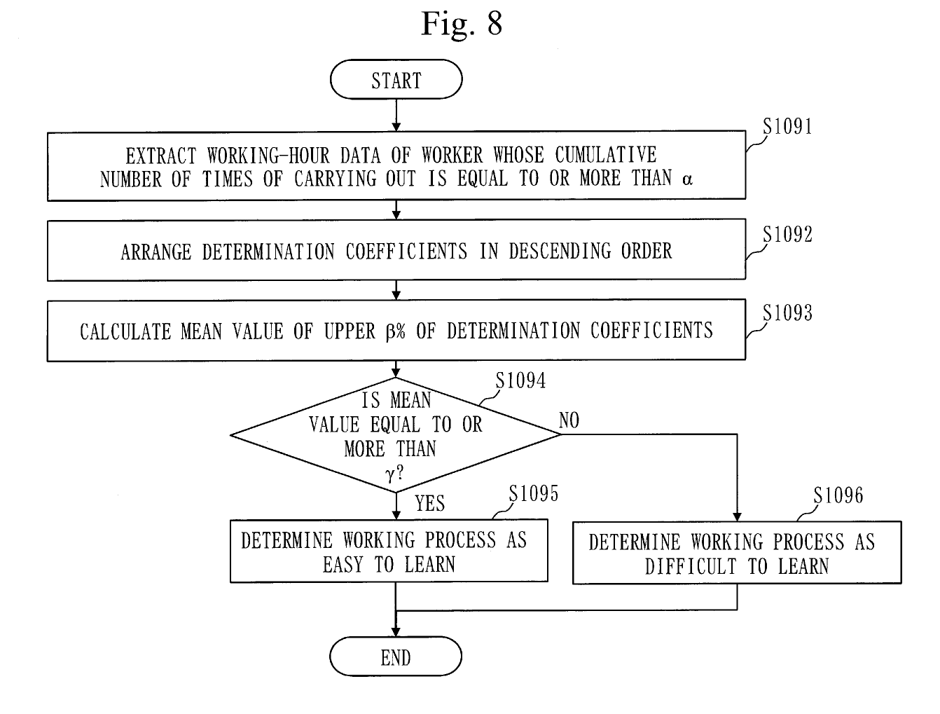

Specifically, the learning easiness determination unit 104 determines easiness to learn of each working process, according to the procedure described in FIG. 8. The learning easiness determination unit 104 repeats the procedure described in FIG. 8, and determines easiness to learn for each of the working processes 1 to 5.

It is assumed that concrete numerical values of α, β and γ indicated in FIG. 8 are set by a work manager. Hereinafter, each step in FIG. 8 is described.

First, the learning easiness determination unit 104 extracts working-hour data of a worker whose cumulative number of times of carrying out is equal to or more than α times (step S1091), about a working process which is an object of determination on learning easiness.

At a stage wherein a cumulative number of times of carrying out is small, since a worker is not familiar with the work, the working hours vary greatly. Therefore, there is a possibility of not being able to determine learning easiness of working processes accurately, when using working-hour data of a worker whose cumulative number of times of carrying out is small. Accordingly, the learning easiness determination unit 104 only uses working-hour data of workers whose cumulative number of times of carrying out is equal to or more than a fixed number (α times) for determination on learning easiness of a working process.

Next, the learning easiness determination unit 104 arranges determination coefficients of workers whose working-hour data is extracted in the step S1091 in descending order (step S1092).

Next, the learning easiness determination unit 104 calculates a mean value of determination coefficients in the top β% of the determination coefficients arranged in the step S1092 (step S1093). Further, the learning easiness determination unit 104 handles the mean value of the determination coefficients in the top β% as learning easiness of each working process.

A worker with low determination coefficient of a certain working process often has poor learning ability in all working processes. Therefore, there is a possibility of not being able to determine learning easiness of working processes accurately, when using determination coefficients of low values. Thus, the learning easiness determination unit 104 uses the top β% of the determination coefficients as an index of learning easiness.

Next, the learning easiness determination unit 104 determines whether the mean value calculated in the step S1093 is equal to or more than a threshold value γ (step S1094).

The learning easiness determination unit 104 determines working processes whose mean value is equal to or more than the threshold value γ as working processes easy to learn (step S1095). Meanwhile, the learning easiness determination unit 104 determines working processes whose mean value is less than the threshold value γ as working processes difficult to learn (step S1096).

Next, explanation is provided of a determination procedure of learning ability of workers by the learning ability determination unit 106.

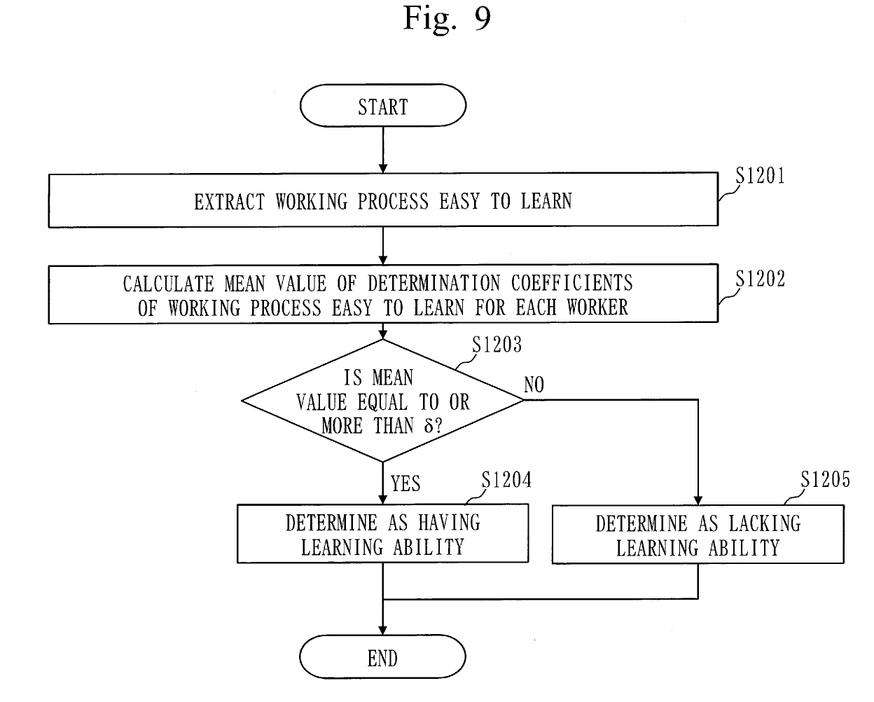

Specifically, the learning ability determination unit 106 determines learning ability of each worker according to the procedure illustrated in FIG. 9. It is assumed that a specific numerical value of δ illustrated in FIG. 9 is set by a work manager. Hereinafter, each step in FIG. 9 is described.

First, the learning ability determination unit 106 extracts working processes (hereinafter called working processes easy to learn) determined to be easy to learn in the step S1095 of FIG. 8 (step S1201).

The working process determined to be difficult to learn is difficult to learn even when a worker having high learning ability handles, and determination coefficient is low. There is a possibility of not being able to determine learning ability of workers accurately when using determination coefficients of working processes determined to be difficult to learn. Therefore, the learning ability determination unit 106 extracts working processes which are easy to learn.

Next, the learning ability determination unit 106 calculates, for each worker, a mean value of the determination coefficients of the working processes easy to learn, which are extracted in the step S1201 (step S1202). The learning ability determination unit 106 handles the mean value calculated as learning ability of each worker.

For example, it is supposed a case wherein the worker A is in charge of the working process 1 and the working process 2, and a worker B is in charge of the working process 2 and the working process 3. If the working processes 1, 2 and 3 are working processes that are easy to learn, as for the worker A, the learning ability determination unit 106 calculates a mean value of a determination coefficient with respect to the working process 1 and a determination coefficient with respect to the working process 2. Further, as for the worker B, the learning ability determination unit 106 calculates a mean value of a determination coefficient with respect to the working process 2 and a determination coefficient with respect to the working process 3.

Next, the learning ability determination unit 106 determines whether the mean value calculated in the step S1202 is equal to or more than a threshold value δ for each worker (step S1203).

The learning ability determination unit 106 determines a worker whose mean value is equal to or more than the threshold value δ as a worker having learning ability (step S1204).

Meanwhile, the learning ability determination unit 106 determines a worker whose mean value is less than δ as a worker lacking learning ability (step S1205).

Next, explanation is provided of a procedure of division determination of working processes by the process division unit 108.

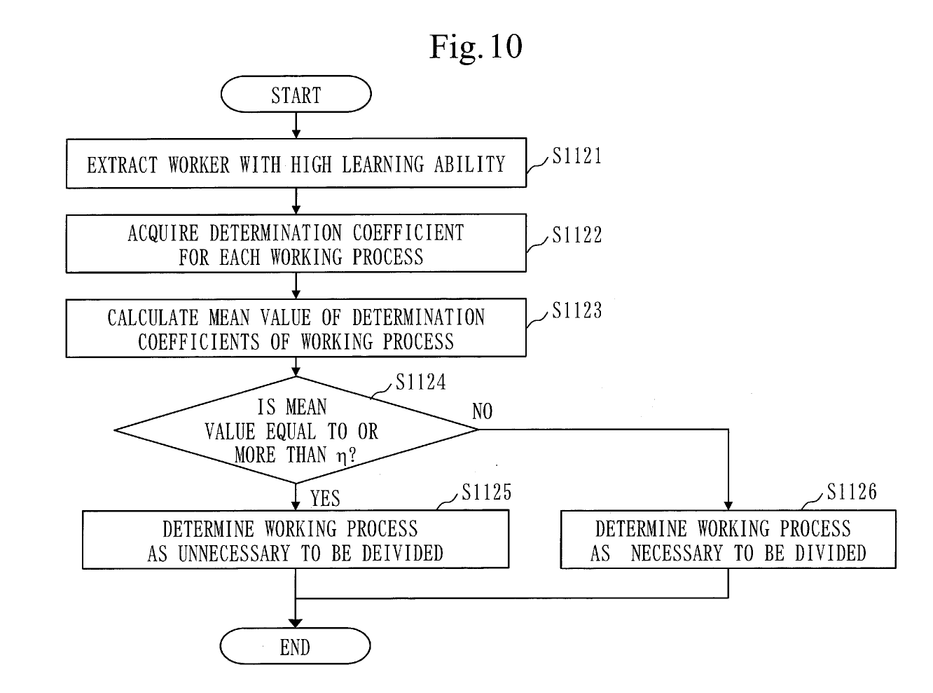

Specifically, the process division unit 108 determines whether to divide a working process, according to the procedure illustrated in FIG. 10. Note that a specific numerical value of η illustrated in FIG. 10 is set by a work manager. Hereinafter, each step in FIG. 10 is described.

In a step S1121, the process division unit 108 extracts workers with high learning ability through all working processes. That is, the process division unit 108 extracts workers with high learning ability in the learning ability of each worker determined by the learning ability determination unit 106 according to the procedure of FIG. 9.

Next, in a step S1122, the process division unit 108 acquires a determination coefficient for each working process.

More specifically, the process division unit 108 acquires a determination coefficient for each working process of the workers (selected workers) extracted in the step S1121 from the determination coefficient database 114.

For example, it is supposed a case wherein the worker A and the worker B are extracted in the step S1121, the worker A is in charge of the working process 1 and the working process 2, and the worker B is in charge of the working process 2 and the working process 3. The process division unit 108 acquires a determination coefficient in the working process 1 of the worker A and a determination coefficient in the working process 2 of the worker A. Similarly, the process division unit 108 acquires a determination coefficient in the working process 2 of the worker B and a determination coefficient in the working process 3 of the worker B.

In this manner, the process division unit 108 acquires determination coefficients of the workers extracted in S1121 for each working process.

Next, in a step S1123, the process division unit 108 calculates a mean value of determination coefficients for each action process.

That is, the process division unit 108 calculates a mean value for each working process of the determination coefficients acquired in the step S1122.

Next, in a step S1124, the process division unit 108 determines whether the mean value of determination coefficients is equal to or more than the threshold value n for each working process.

When the mean value of the determination coefficients is equal to or more than the threshold value η (YES in the step S1124), the process division unit 108 determines the working process as a working process that is unnecessary to be divided (step S1125).

Meanwhile, when the mean value of the determination coefficients is less than the threshold value η (NO in the step S1124), the process division unit 108 determines the working process as a working process that should be divided (step S1126).

For example, when the mean value of the determination coefficients of the working process is less than the threshold value η, the process division unit 108 determines that the working process 1 should be divided.

***Explanation of Effect of Embodiment***

As described above, in the division determination of working processes, it is possible to determine with high accuracy by considering determination coefficients for each working process.

***Explanation of Hardware Configuration***

Lastly, a supplementary explanation of the hardware configuration of the information processing device 100 will be provided.

The processor 11 illustrated in FIG. 2 is an integrated circuit (IC) that performs processing.

For example, the processor 11 is a central processing unit (CPU), a digital signal processor (DSP), etc.

The memory 12 illustrated in FIG. 2 is, for example, a random access memory (RAM).

The storage 13 illustrated in FIG. 2 is, for example, a read only memory (ROM), a flash memory, a hard disk drive (HDD), etc.

The communication device 14 illustrated in FIG. 2 includes a receiver to receive data, and a transmitter to transmit data.

The communication device 14 is, for example, a communication chip or a network interface card (NIC).

The input device 15 is, for example, a mouse or a keyboard.

The display device 16 is, for example, a display.

The storage 13 also stores an operating system (OS).

Then, at least part of the OS is loaded into the memory 12, and executed by the processor 11.

The processor 11 executes the programs to realize the functions of the communication processing unit 101, the learning easiness determination unit 104, the learning ability determination unit 106, the process division unit 108, the display processing unit 109, the work plan optimization unit 110, the learning curve creation unit 111 and the determination coefficient calculation unit 113 while executing at least a part of the OS.

With the processor 11 executing the OS, task management, memory management, file management, communication control, etc. are performed.

Further, information, data, signal values or variable values indicating the results of the processing by the communication processing unit 101, the learning easiness determination unit 104, the learning ability determination unit 106, the process division unit 108, the display processing unit 109, the work plan optimization unit 110, the learning curve creation unit 111 and the determination coefficient calculation unit 113 are stored in at least any of the memory 12, the storage 13, or a register or a cache memory in the processor 11.

Further, the programs to realize the functions of the communication processing unit 101, the learning easiness determination unit 104, the learning ability determination unit 106, the process division unit 108, the display processing unit 109, the work plan optimization unit 110, the learning curve creation unit 111 and the determination coefficient calculation unit 113 may be stored in a portable recording medium such as a magnetic disk, a flexible disk, an optical disc, a compact disk, a blue-ray (registered trademark) disc, a digital versatile disc (DVD), etc.

Furthermore, the “units” of the communication processing unit 101, the learning easiness determination unit 104, the learning ability determination unit 106, the process division unit 108, the display processing unit 109, the work plan optimization unit 110, the learning curve creation unit 111 and the determination coefficient calculation unit 113 may be replaced with “circuits,” “steps,” “procedures” or “processing.”

Further, the information processing device 100 may be realized by electronic circuits such as a logic integrated circuits (logic IC), a gate array (GA), an application specific integrated circuit (ASIC) or a field-programmable gate array (FPGA), etc.

The processor and the electronic circuit as described above are collectively referred to as “processing circuitry”.

### REFERENCE SIGNS LIST

100: information processing device; 101: communication processing unit; 102: working-hour collection database; 103: work plan database; 104: learning easiness determination unit; 105: learning easiness database; 106: learning ability determination unit; 107: learning ability database; 108: process division unit; 109: display processing unit; 110: work plan optimization unit; 111: learning curve creation unit; 112: learning curve database; 113: determination coefficient calculation unit; 114: determination coefficient database; 115: decreasing index value calculation unit; 200: collection data server device; 300: factory production line; 301: working facility; 302: working facility; 303: working facility; 304: working facility; 305: working facility; 401: network; 402: network

1-9. (canceled)

10. An information processing device comprising:
processing circuitry to:
select a worker that matches a selection condition from a plurality of workers, and
analyze, with respect to a selected worker being the worker selected, a decreasing state of a working hour due to increase in the number of times of carrying out a working process, and determine whether to divide the working process or not.

11. The information processing device as defined in claim 10,
wherein the processing circuitry determines, when the working hour does not decrease even when the number of times of carrying out increases in the working process, that the working process should be divided.

12. The information processing device as defined in claim 10,
wherein the processing circuitry calculates, for each worker, by using working-hour data wherein a history of a working hour of the plurality of workers in the working process is indicated for each worker, a decreasing index value being an index value to represent a decreasing state of the working hour due to increase in the number of times of carrying out the working process, and
wherein the processing circuitry analyzes a decreasing index value of the selected worker, and determines whether to divide the working process or not.

13. The information processing device as defined in claim 12, wherein
the processing circuitry calculates a mean value of the decreasing index value of the selected worker, and when the mean value calculated is less than a threshold value, determines that the working process should be divided.

14. The information processing device as defined in claim 12, wherein
the processing circuitry creates, for each worker, by using the working-hour data, a learning curve indicating a relation between the number of times of carrying out the working process and the working hour, and calculates a determination coefficient between the learning curve and the history of the working hour indicated in the working-hour data, as the decreasing index value, and
wherein the processing circuitry analyzes a determination coefficient of the selected worker, and determines whether to divide the working process or not.

15. The information processing device as defined in claim 10,
wherein the processing circuitry determines learning ability of each of the plurality of workers, and
wherein the processing circuitry selects a worker whose learning ability determined matches the selection condition.

16. The information processing device as defined in claim 10
wherein the processing circuitry optimizes a working plan based on a working process after division when any working process is divided.

17. An information processing method comprising:
selecting a worker that matches a selection condition from a plurality of workers, and
analyzing, with respect to a selected worker being the worker selected, a decreasing state of a working hour due to increase in the number of times of carrying out a working process, and determining whether to divide the working process or not.

18. A non-transitory computer readable medium storing an information processing program to cause a computer to execute:
a worker selecting process to select a worker that matches a selection condition from a plurality of workers, and
a division determination process to analyze, with respect to a selected worker being the worker selected by the worker selecting process, a decreasing state of a working hour due to increase in the number of times of carrying out a working process, and to determine whether to divide the working process or not.
